(19) United States
(12) Patent Application Publication
(10) Pub. No.: US 2017/0292220 A1
(43) Pub. Date: Oct. 12, 2017

(54) FIBER TOW SURFACE TREATMENT SYSTEM

(71) Applicant: FORD GLOBAL TECHNOLOGIES, LLC, Dearborn, MI (US)

(72) Inventors: HAIBO ZHAO, NORTHVILLE, MI (US); GLEN L. SMITH, DEARBORN, MI (US); ANN MARIE STRACCIA, SOUTHGATE, MI (US)

(21) Appl. No.: 15/093,852

(22) Filed: Apr. 8, 2016

(51) Int. Cl. D06M 10/02; B29B 13/08

(52) U.S. Cl. CPC D06M 10/025; B29B 13/08; D06M 2101/40

(57) ABSTRACT

Systems and methods for plasma treating fiber tows (e.g., carbon fiber tows) are disclosed. The system may be a fiber tow treatment system, including an air-plasma source configured to emit a plasma stream and a support surface spaced apart from the air-plasma source and configured to contact the plasma stream when emitted. First and second guides may be on opposing ends of the support surface and configured to align a moving fiber tow between the support surface and the air-plasma source. The method may include continuously transferring a fiber tow through a first guide, across a support surface, and through a second guide; and air-plasma treating the fiber tow as it crosses the support surface such that a deflection of the fiber tow from the air-plasma treatment is limited by the support surface. The disclosed systems/methods may reduce the damage to fiber tows during plasma treatment.

### TECHNICAL FIELD

The present disclosure relates to fiber tow surface treatment systems, for example, carbon fiber tow surface treatment.

### BACKGROUND

Increased fuel economy is an important goal for vehicle manufacturers. The desire for improved fuel economy may be driven by fuel costs, emissions standards (e.g., for carbon dioxide), improved range, or other reasons. One approach to improving fuel economy is using lightweight materials to reduce vehicle weight. Carbon fiber is a low-density material with good mechanical properties. Currently, carbon fiber is generally used in applications such as aerospace, wind energy, sporting goods, and high-end vehicles. These applications are generally lower in volume and higher in price compared to high-volume vehicles. Implementation of carbon fiber into high-volume, non-luxury vehicles in the auto industry poses some challenges. One of the challenges is developing low-cost processing technology for high-volume production. A sheet molding compound (SMC) process has been used to manufacture glass fiber reinforced parts, such as decklids, hoods, bumpers, and others. However, the same SMC process may not be suitable for carbon fibers due to differences in the physical properties of the two fiber types.

### SUMMARY

In at least one embodiment, a fiber tow treatment system is provided. The system may include an air-plasma source configured to emit a plasma stream; a support surface spaced apart from the air-plasma source and configured to contact the plasma stream when emitted from the air-plasma source; and first and second guides on opposing ends of the support surface and configured to align a moving fiber tow between the support surface and the air-plasma source.

The support surface may be configured to reduce a deflection of the fiber tow when it is treated by the plasma stream to at most 3 mm. The support surface may be from 5 to 20 mm from the air-plasma source. The first and second guides may be configured to maintain the fiber tow in a flat orientation while being treated by the plasma stream. The system may further include a third guide configured to receive the fiber tow and align it with the first and second guides. In one embodiment, the air-plasma source is an atmospheric-pressure air plasma probe.

In another embodiment, the air-plasma source is configured to generate a plasma curtain. The system may include a plurality of support surfaces perpendicular to the air-plasma source and in a path of the plasma curtain; and a plurality of sets of first and second guides, each set configured to align a fiber tow between the support surface and the air-plasma source to be treated by the plasma curtain. In one embodiment, the system includes a take-up roll configured to receive the fiber tow after it has been treated by the plasma stream. In another embodiment, the system includes a chopper configured to cut the fiber tow into segments after it has been treated by the plasma stream. In one embodiment, the system may include a second air-plasma source configured to emit a second plasma stream; and a second support surface perpendicular to the second air-plasma source and in a path of the second plasma stream.

In at least one embodiment, a method is provided. The method may include continuously transferring a fiber tow through a first guide, across a support surface, and through a second guide; and air-plasma treating the fiber tow as it crosses the support surface such that a deflection of the fiber tow from the air-plasma treatment is limited by the support surface.

The air-plasma treatment may be from a direction perpendicular to the support surface. The method may include maintaining the fiber tow at a spacing of 3 mm or less from the support surface as it is continuously transferred across the support surface. In one embodiment, the method may include maintaining the fiber tow at a distance of 5 mm to 15 mm from a tip of an air-plasma source as it is continuously transferred across the support surface. A tension in the fiber tow may be maintained at 1 to 12 MPa while it is continuously transferred through the first guide, across the support surface, and through the second guide. In one embodiment, the method may include continuously transferring multiple fiber tows across a support surface; and air-plasma treating the fiber tows using a plasma curtain as they cross the support surface. The method may include winding the fiber tow onto a roll after the air-plasma treatment or chopping the fiber tow into a plurality of segments after the air-plasma treatment.

In at least one embodiment, a method is provided. The method may include continuously transferring a fiber tow through a first guide, across first and second support surfaces, and through a second guide; and air-plasma treating the fiber tow from a first direction as it crosses the first support surface and from a second direction as it crosses the second support surface, such that a deflection of the fiber tow from the air-plasma treatments is limited by the first and second support surfaces.

### BRIEF DESCRIPTION OF THE DRAWINGS

FIG. 1 is a schematic perspective view of a system for plasma treating a fiber tow, according to an embodiment;

FIG. 2 is a front perspective view of a fiber tow guide, according to an embodiment;

FIG. 3 is a rear perspective view of a fiber tow guide, according to an embodiment;

FIG. 4 is a rear perspective view of another fiber tow guide, according to an embodiment;

FIG. 5 is a side perspective view of a system for plasma treating a fiber tow including a support plate positioned under the plasma source, according to an embodiment;

FIG. 6 is a schematic view of a system for plasma treating a fiber tow, according to another embodiment;

FIG. 7 is XPS data comparing untreated carbon fibers and carbon fibers treated according to the disclosed systems and methods;

FIG. 8 is a graph of binding energy for untreated, plasma treated, and aged plasma treated carbon fibers showing an increase in alcohol groups for the plasma treated fibers (aged and non-aged);

FIG. 9 is XPS data comparing untreated carbon fibers and carbon fibers treated according to the disclosed systems and methods;

FIG. 10 is an SEM at 50× magnification of a non-treated carbon fiber composite following a fracture test;

FIG. 11 is an SEM at 250× magnification of the non-treated carbon fiber composite;

FIG. 12 is an SEM at 50× magnification of a carbon fiber composite wherein the fibers were plasma treated according to the disclosed methods following a fracture test;

FIG. 13 is an SEM at 250× magnification of the carbon fiber composite; and

FIG. 14 is a plot of tensile strength data for an untreated carbon fiber composite and a carbon fiber composite wherein the fibers were treated according to the disclosed methods.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As described in the Background, the SMC process used to manufacture glass fiber reinforced parts may not be suitable for producing carbon fiber reinforced parts. The bundling of carbon fibers can cause issues in the SMC process. For example, it may be difficult for resin to wet out (e.g., fully impregnate) the carbon fibers and the fibers may not flow well during molding. The surface properties of the carbon fibers may also hinder the wet out of the resin. These issues may result in relatively low surface contact between the carbon fibers and the resin. Due to these issues, carbon fiber reinforced SMC parts have not yet met the required mechanical performance for some applications. An economical and effective method to improve the carbon fiber separation in the carbon fiber SMC process may improve final part performance.

A carbon tow is a bundle of individual carbon fiber filaments or strands that form a larger strand. Carbon tows may be woven together into cloth or a weave. Carbon tows may be defined or classified by size, such as 3 k, 6 k, 12 k, 24 k, 36 k, 48 k, or higher, where the “k” represents a thousand filaments. For example, a 12 k carbon tow may include 12,000 carbon filaments. Carbon tows may come in a variety of sizes, and the size chosen may depend on the application. The diameter of the filaments may also vary depending on the desired properties or the application. The diameter of the filaments may vary, for example, from 1 to 25 microns, or sub-ranges therein, such as 5 to 15 microns or 5 to 10 microns. The tow may have a roughly rectangular cross-section having a width and a height. The width of the tow may vary depending on the number and size of the filaments, for example, the width may be from 3 to 25 mm, or any sub-range therein, such as 3 to 20 mm or 5 to 15 mm. The height of the tow may similarly vary, but may be from 25 μm to 1 mm, or any sub-range therein, such as 25 μm to 500 μm or 25 μm to 100 μm.

The production of carbon fiber and carbon fiber tows is known in the art, and will not be described in detail. In general, the production of carbon fiber tows includes the steps of polymerization, spinning, oxidation, carbonization, and surface treatment. However, there are multiple methods for producing carbon fiber tows and any method may be compatible with the present disclosure. Polymerization generally includes converting a polymeric feedstock (e.g., precursor) into a material that can be formed into fibers. In general, fibers may be formed from polyacrylonitrile (PAN), made from acrylonitrile, however fiber may also be formed from other precursors such as rayon or pitch-based precursors. The precursor may be in a powder form and may be dissolved in a solvent, such as an organic or aqueous solvent, to form a slurry.

Fibers may be formed by spinning, such as wet spinning. The slurry may be immersed in a coagulant and extruded through holes in a bushing or spinneret having a number of holes that matches the desired filament count of the tow. The wet-spun fiber may be washed, dried, and stretched. While wet spinning is one approach to forming carbon fibers, others known in the art may also be used. After drying, the fibers may be wound, for example, onto bobbins.

The fibers, which may be wound or rolled, may then be inserted or fed through one or more ovens during the oxidation step. The oxidation temperature may range from about 200° C. to 300° C. The process may cause the polymer chains to crosslink and increase in density. The oxidized fibers may contain about 50 to 65 percent carbon molecules after oxidation, with elements such as hydrogen, nitrogen and oxygen forming the balance.

In the carbonization step, the fibers are heated again but in an inert or oxygen-free atmosphere. Without oxygen, non-carbon molecules are removed from the fibers. The carbonization step may include heating at one or more temperatures, for example, a first, lower temperature and a second, higher temperature. The temperatures may range, for example, from 700° C. to 1500° C. The fibers may held in tension throughout the production process. During carbonization, crystallization of the carbon molecules occurs and the finished fiber may be more than 90 percent carbon.

After carbonization, the fibers may receive a surface treatment and/or a coating named sizing. The surface treatment may include pulling the fiber through an electrochemical or electrolytic bath that contains solutions to etch or roughen the surface of each filament. A coating, generally called sizing, may then be applied to the fibers. The sizing is intended to protect the carbon fibers during handling and processing so that the fiber surfaces are not scratched or damaged. After the sizing is applied and has dried, the fiber tows are generally bundled or wound-up for later use (e.g., on bobbins).

As described above, one of the challenges to using carbon fiber in the SMC process is resin wet out on the carbon fiber surface. It has been found that one potential solution to improve wet out is to change the surface property of carbon fibers and reduce the contact angle of resin on carbon fibers. Increasing the surface energy of the carbon fibers may reduce the contact angle with the resin and improve the wet out with the resin. In one embodiment, a plasma treatment may be used to increase the surface energy of the carbon fibers in the tow. The plasma treatment may be an atmospheric-pressure air plasma (APAP). It has been found that using APAP to treat carbon fibers may increase the polar groups on carbon fiber surface, thereby increasing the surface energy and allowing the resin to wet out easier.

However, the APAP process typically exerts high-pressure plasma, which can deform and/or damage a non-supported carbon fiber tow. Damaged tows may cause subsequent processing issues and/or product defects. In addition to potential deformation or damage, non-supported carbon fiber tows also deflect under the pressure of the APAP process. As a result of the deflection, the carbon fiber tow may receive inconsistent and/or ineffective plasma dosages during the treatment.

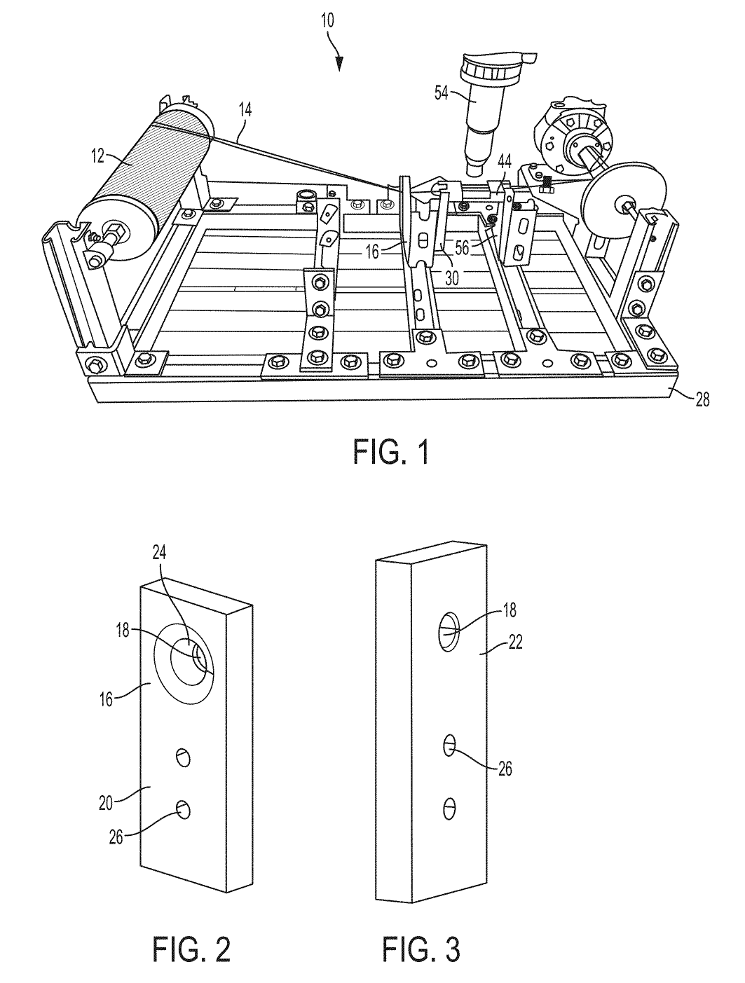

With reference to FIGS. 1-6, systems and methods for plasma treating a fiber tow (e.g., carbon fiber) are disclosed. The systems and methods may plasma treat the fibers while supporting the fibers and preventing or reducing fiber deformation or damage during the plasma treatment. The system may also prevent deflection of the fibers during the plasma treatment to provide a consistent and effective plasma dosage. The disclosed systems and methods may reduce the contact angle between the fibers and the resin and improve resin wet out, resulting in improved mechanical properties of the fiber composite.

With reference to FIG. 1, an embodiment of a fiber tow surface treatment system 10 is shown. The system 10 may be configured to receive a bobbin or spool 12 of fiber tow 14, such as carbon fiber tow. In one embodiment, shown in FIG. 1, the bobbin 12 may be rotatably supported such that it is allowed to rotate and the fiber tow 14 can be unwound (e.g., by pulling on a free end of the tow). In another embodiment, the bobbin 12 may be configured to stay stationary and the fiber tow 14 may be pulled from the bobbin 12 in a direction parallel to the long axis of the bobbin 12. In this embodiment, the fiber tow 14 may unravel from the bobbin 12 without the bobbin 12 rotating. However, any suitable configuration to continuously unwind the fiber tow 14 from the bobbin 12 may be used.

Once the fiber tow 14 is unraveled from the bobbin 12, it may be passed through a first guide 16. Front and rear perspective views of one embodiment of a first guide 16 are shown in FIGS. 2 and 3, respectively. The first guide 16 may have an aperture or hole 18 defined therein that extends from a front surface 20 to a rear surface 22 of the first guide 16. The aperture 18 may be configured to receive the fiber tow 14. In one embodiment, the aperture 18 may have a larger width or diameter at the front surface 20 than at the rear surface 22. The diameter of the aperture 18 at the rear surface 22 may be configured to be slightly larger than a width of the fiber tow 14, thereby guiding the fiber tow 14 in a direction of the aperture 18 as it exits the rear surface 22 of the first guide 16. A wall 24 of the aperture 18 may extend from the front surface 20 to the rear surface 22. In embodiments where the diameter of the aperture 18 decreases from the front surface 20 to the rear surface 22, the wall 24 may have a constantly changing diameter. In one embodiment, the wall 24 may be filleted such that the wall 24 is rounded between the front surface 20 and the rear surface 22. The fillet may have a radius, for example, a radius of 0.2 to 0.5 inches, or any sub-range therein, such as 0.25 to 0.45 inches or 0.3 to 0.4 inches. In addition to the aperture 18, the first guide 16 may include additional holes 26, which may be configured to receive fasteners to secure the first guide 16 to a base 28 of the system 10 or to other components in the system.

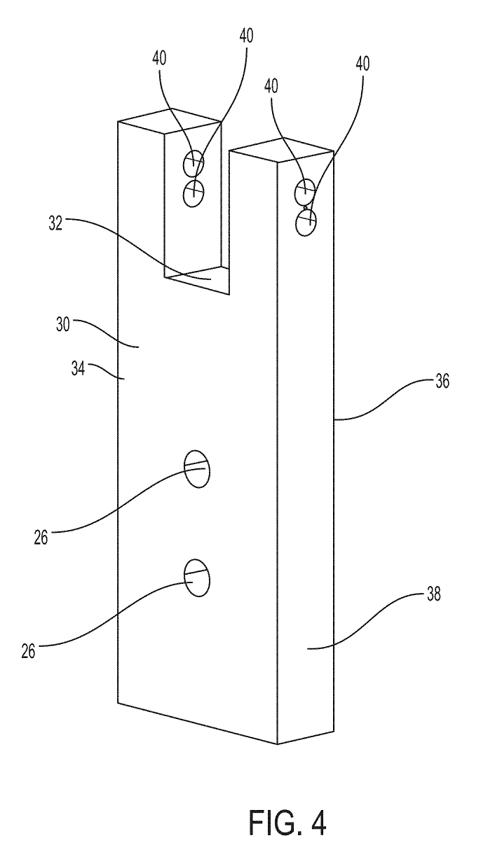

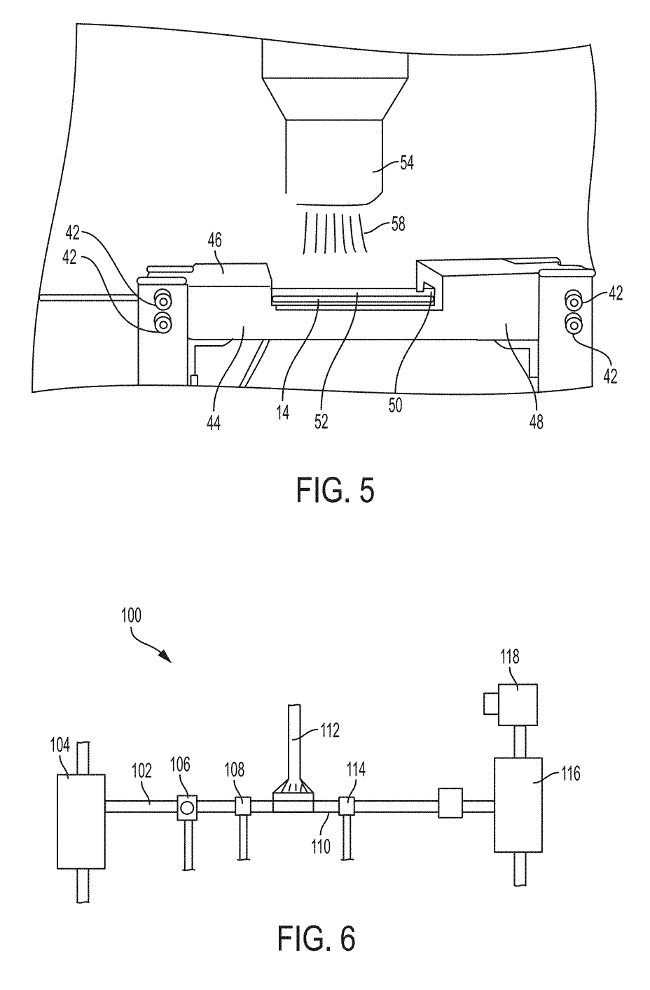

After the fiber tow 14 passes through the first guide 16, it may pass through a second guide 30. A perspective view of an embodiment of a second guide 30 is shown in FIG. 4. Similar to the first guide 16, the second guide 30 may include holes 26 for attaching the second guide 30 to the base 28 or other components of the system 10. The second guide 30 may have a channel 32 defined therein. Extending from a front surface 34 to a rear surface 36 of the second guide 30. A side wall 38 of the second guide 30 may have defined therein a pair of bores 40 on each side of the channel 32. The bores may be configured to receive rods or pins 42, as shown in FIGS. 1 and 5. The bores 40 and rods 42 may be vertically spaced. The spacing may be slightly larger than a height of the fiber tow 14 but smaller than a width of the fiber tow 14. For example, the spacing may be less than 5 mm, such as less than 3 mm, less than 1 mm, or less than 0.5 mm (500 μm).

The second guide 30 may be configured to receive the fiber tow 14 through the spacing between the rods 42. Since the spacing between the rods may be only slightly larger than the height of the fiber tow 14 and less than the width of the tow, the rods 42 may maintain the tow in a flat position with its width parallel to the rods 42. The rods 42 may be fixed within the bores 40 or may be free to rotate within the bores 40. Accordingly, the second guide 30 may receive the fiber tow 14 from the aperture 18 of the first guide 16 and may orient the tow 14 in a horizontal or flat position as it exits the second guide 30. While the second guide 30 is shown and described as using rods 42 to maintain the orientation, other configurations that provide the same function may also be used.

After the fiber tow 14 passes through the second guide 30, it may be received by a support plate 44. An embodiment of a support plate 44 is shown in FIG. 5. The support plate 44 may have a first end 46 and a second end 48. The first and second ends may each have defined therein a channel 50 configured to receive the fiber tow 14. The channels 50 may be slightly larger in width and height than the fiber tow 14, but may have a horizontal orientation (e.g., wider than tall) to facilitate maintaining the fiber tow 14 in a flat orientation. Between the first and second ends may be a support surface 52. The support surface 52 may extend between the first end 46 and the second end 48. In one embodiment, the support surface extends between the bottoms of the channels 50.

The support surface 52 may be positioned under a plasma probe 54 of a plasma system, for example, an atmospheric-pressure air plasma (APAP) system. In one embodiment, the support surface 52 may be horizontal or substantially horizontal (e.g., ±5°) relative to the ground. The plasma probe 54 may be configured to be vertical or substantially vertical (e.g., ±5°) relative to the ground. Accordingly, the plasma probe 54 may be perpendicular to the support surface 52 (e.g., ±5°), such that the plasma stream direction is perpendicular to the support surface 52. The vertical distance or offset from the support surface 52 to the tip of the plasma probe 54 may therefore be constant or substantially constant (e.g., ± up to 5 mm).

After the fiber tow 14 passes through the support plate 44, it may pass through a third guide 56. The third guide 56 may be the same or substantially similar to the second guide 30, an embodiment of which is shown in FIG. 4 and described above. However, while the third guide 56 may be the same or similar to second guide 30, other configurations that provide the same function may also be used. The second guide 30 and the third guide 56 may be disposed on opposite sides of the support plate 44. The second guide 30 may be adjacent to the first end 46 of the support plate 44 and the third guide 56 may be adjacent to the second end 48 of the support plate 44. The spaced rods 42 of the second and third guides may be aligned with the channels 50 in the first and second ends of the support plate 44, respectively. Accordingly, the fiber tow 14 may pass between the spaced rods 42 of the second guide 30, through the channel 50 in the first end 46 of the support plate 44, across the support surface 52, through the channel 50 in the second end 48 of the support plate 44, and through the spaced rods 42 of the third guide 56.

As the fiber tow 14 passes across the support surface, it may receive a plasma treatment from the plasma probe 54, such as an APAP treatment. The first, second, and third guides and the channels in the support plate may be configured such that the fiber tow 14 is in very close proximity to the support surface 52 as it passes thereover (e.g., without plasma being applied). The guides/channels may even be configured such that the fiber tow 14 is in contact with the support surface 52 as it passes thereover. In one embodiment, the guides/channels may be configured such that the fiber tow 14 has a vertical spacing of 0 to 10 mm from the support surface 52 as it passes thereover, or any sub-range therein, such as 0 to 5 mm, 0 to 3 mm, or 0 to 1 mm. In another embodiment, the guides/channels may be configured such that the fiber tow 14 has a vertical spacing of 0.1 to 10 mm from the support surface 52 as it passes thereover, or any sub-range therein, such as 0.1 to 5 mm, 0.1 to 3 mm, or 0.1 to 1 mm.

When the plasma probe 54 is activated, a plasma plume or stream 58 may be directed towards the fiber tow 14 as it passes over the support surface 52. The shape of the plasma stream 58 may depend on the plasma source type. The stream may have a circular cross-section or an elongated rectangular cross-section (e.g., planar or curtain-like). The plasma stream 58 exerts a pressure on the fiber tow 14. The pressure exerted may depend on the plasma system used, the operating parameters, distance and speed of treatment, nozzle design, and other factors. In one embodiment, the operating pressure of the plasma probe 54 may be at least 20 millibar (mbar), for example, at least 25 mbar or at least 30 mbar. The pressure may generally be less than 150 mbar or less than 140 mbar.

The pressure from the plasma stream 58 is generally sufficient to deform or damage the filaments of the fiber tow. Without a support underneath, the tow 14 may be blown apart and/or deflected downward or in a direction opposite the probe 54. In addition to damaging the tow, the deflection may cause the fiber tow to receive inconsistent plasma treatment. The plasma dosage may be a function of the treatment distance (e.g., from the tip of the probe to the substrate). Accordingly, by deflecting the tow away from the probe, an unsupported tow may not maintain a constant treatment distance, which may result in inconsistent plasma treatment of the tow.

However, the support surface 52 may prevent or mitigate the damage or inconsistent plasma dosage. By providing support to the bottom or underside of the tow (relative to the probe), the fiber tow 14 may not deflect, or may deflect a very small amount, as it passes over the support surface 52. This may prevent the filaments of the tow from being blown apart, deformed, and/or broken. In addition, the fiber tow 14 cannot deflect more than a very small amount away from the probe 54, thereby providing a constant treatment distance and consistent plasma dosage to the fiber tow 14. In general, the plasma dosage may increase with decreased treatment distance and speed/velocity of the fiber tow 14. In one embodiment, the fiber tow 14 and/or the support surface 52 (e.g., top surfaces thereof) may be configured to be from 3 to 20 mm from the tip of the plasma probe 54, or any sub-range therein, such as 5 to 20 mm, 5 to 15 mm, or 6 to 12 mm. The speed of the fiber tow 14 as it passes over the support surface 52 may be from 50 mm/s to 1,000 mm/s, or any sub-range therein, such as 50 mm/s to 800 mm/s, 50 mm/s to 700 mm/s, 100 mm/s to 800 mm/s, 100 mm/s to 700 mm/s, 50 mm/s to 600 mm/s, 100 mm/s to 600 mm/s, 50 mm/s to 450 mm/s, 50 mm/s to 300 mm/s, or 100 mm/s to 300 mm/s.

Accordingly, in operation, the system 10 may pull a fiber tow from a bobbin, spool, or other source of fiber tow. The fiber tow may then be passed through a first guide and a second guide and across a support surface. A plasma probe, such as an APAP probe, may be positioned perpendicular to the support surface (e.g., above or below) and may emit a plasma stream onto the fiber tow as it passes over the support surface. The support surface may prevent the fiber tow from deflecting under the pressure of the plasma stream, thereby maintaining a consistent plasma dosage applied to the tow. The support surface also reduces the damage caused to the fiber tow from the plasma stream pressure. After crossing the support surface, the fiber tow may pass through a third guide.

After the fiber tow exits the third guide, it may be either rewound onto a bobbin, spool, or roll, similar to the one it initially came from, or it may be chopped into smaller segments. In the embodiment shown in FIG. 1, the fiber tow is rewound onto a bobbin. For example, the third guide 56 or a separate guide may move back and forth along a long axis of the bobbin to wind the fiber tow evenly. The bobbin may be rotated to pull the fiber tow from the original bobbin 12 through the guides and onto the final bobbin (e.g., plasma-treated bobbin). A motor, such as an electric motor, may be configured to rotate the take-up bobbin.

In at least one embodiment, the tension in the fiber tow may be maintained within a certain range during the treatment process. If the tension is too low, then then fiber tow may not be held straight/taught and in position, but if the tension is too large it may damage the filaments. In one embodiment, the fiber tow may be maintained at a tension between 1 to 12 MPa, or any sub-range therein, during the plasma treatment process (e.g., unwinding, passing through guides, and receiving plasma treatment). For example, the fiber tow may be maintained at a tension between 2 to 10 MPa, 2.5 to 8 MPa, or 3.0 to 6 MPa. The tension may be maintained by the wind-up bobbin, rollers, a combination thereof, or by other methods. The tension in the fiber tow may be monitored using a sensor, either continuously or intermittently (or once at start-up). In one embodiment, one or more sensors may be located in-line with the tow, such that it forms part of the treatment process. The sensor may determine the tension based on parameters such as the angle of the tow and a voltage generated (e.g., voltage of the sensor transducer). One example of a suitable sensor may be a single roll yarn tension sensor. The tension may be affected by parameters such as the tow pulling speed and the resistance of the components of the system (e.g., bearings, rollers, etc.).

With reference to FIG. 6, a simplified schematic of a plasma treating system 100 is shown. The system 100 may operate in a generally similar way to system 10. The system 10 shown in FIG. 1 may be a relatively low-volume system, however, one of ordinary skill in the art will understand, based on the present disclosure, that the system may be scaled up to higher volumes. System 100 shows a more generic system that may be used for low or high volume treatment of fiber tows. A fiber tow 102 may be unrolled from a spool or roll 104 and pulled through a first guide 106 and a second guide 108. While two guides are shown, a single guide or more than two guides may also be used. The tow 102 may then be pulled across a support surface 110 disposed perpendicular to a plasma source 112, which may be an APAP plasma source. As described above, the plasma source may emit a plasma stream that treats the surface of the filaments in the fiber tow.

After the fiber tow is plasma treated, it may be pulled through a third guide 114 and optionally one or more additional guides. The tow 102 may be rewound onto a spool or roll 116 operated by a motor 118, as shown. Alternatively, the treated tow may be processed to be incorporated into a fiber composite, such as a SMC composite. In some embodiments, the fiber tow 102 may be chopped into shorter segments after being plasma treated. The shorter segments may then be collected for later use or they may be directly used to form a SMC sheet. For example, the treated fiber tow may be chopped and allowed to fall onto a film having a resin disposed thereon. The film may then be pressed with another film to form a SMC sheet.

While a single tow is shown as being treated in the systems 10 and 100, multiple tows may also be treated. The systems shown could be duplicated such that there are multiple sets of guides, support plates, plasma probes, etc. in order to increase output and reduce cycle times. In one embodiment, instead of (or in addition to) a plasma probe having a generally circular spot, the plasma source 112 may be a plasma curtain that generates an elongated “curtain” or planar/sheet shaped plasma stream. In this embodiment, multiple fiber tows may be unwound and sent through guides, similar to above, such that they run side-by-side or parallel. Each fiber tow may have a support plate, or there may be a common support plate that provides a support surface to multiple fiber tows. The plasma curtain source may then emit a plasma stream that treats multiple fiber tows at once, with the curtain being perpendicular to the direction of the fiber tow travel. The use of a plasma curtain source may simplify the plasma treatment of multiple tows and reduce the number of plasma sources required. In one embodiment, a plasma curtain source may treat at least 5 fiber tows at once, for example, at least 10, 15, or 20 fiber tows.

In the embodiments described above, a plasma source is configured to treat a fiber tow from a top direction while the fiber tow is supported from a bottom direction. Of course, the directions may be flipped or other configurations may be used. For example, the support surface may be vertical (e.g., relative to the ground) and the plasma probe may be horizontal, such the plasma source is configured to treat the fiber tow from a side direction while the fiber tow is supported from an opposite side direction. In addition, each system may include multiple plasma sources and may plasma treat the fiber tows from more than one direction. For example, in the embodiment shown in FIG. 1, the plasma source treats the fiber from above. However, prior to, or after, treating the fiber tow from above, another plasma source may treat the fiber tow from below. A second support plate may be present and may provide a support surface above the fiber tow to perform the same functions as described above. Accordingly, the systems may include multiple sets of plasma sources and support plates. Alternatively, a single support plate may be configured to provide a support surface on opposite sides of a fiber tow at different locations within the system (e.g., extends below the fiber tow in one position and above the fiber tow in another position).

As described above, the individual filaments of the fiber tows, such as carbon tows, may be relative fragile. To achieve optimal properties from the fibers, damage to the filaments should be avoided during the plasma treating process. The disclosed support plate may reduce damage from the plasma treatment itself, however, other portions of the system should also avoid damaging the fiber tow to the extent possible. In one embodiment, some or all of the components of the systems that interact with or contact the fiber tows may have a smooth surface. For example, metal (or other) components may be polished to eliminate or reduce the possibility of rubbing between the filaments and the components or having sharp features that may damage or break the filaments.

Samples of untreated carbon fiber tow and carbon fiber tow treated using the disclosed systems and methods were tested to determine the effect of the plasma treatment and the treatment system. X-ray Photoelecton Spectroscopy (XPS) was performed to determine the surface chemistry change after an APAP treatment. XPS can measure the amount of oxygen (or polar groups) added to the surface that may aid in resin wet-out and adhesion of the carbon fiber tow in the composite matrix. Treatment was performed with an APAP rotational nozzle from Plasmatreat, NA. Plasma parameters were 8 mm distance with a speed of 150 mm/sec at 60 mbar air pressure at the nozzle.

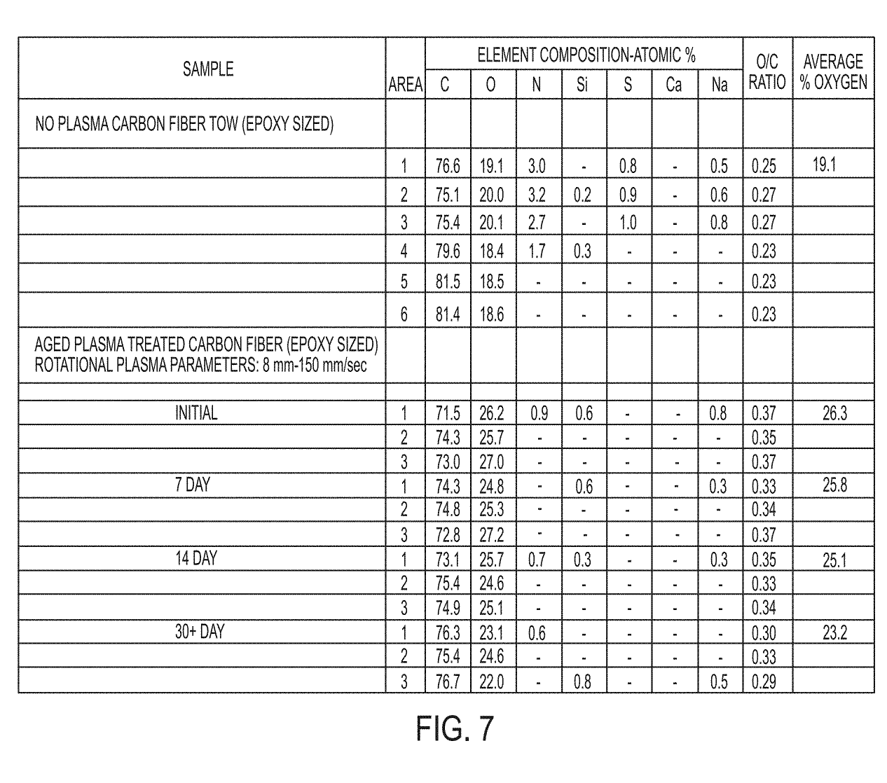

Results of the XPS analysis are shown in FIG. 7. XPS analysis of an as-received epoxy sized carbon fiber tow, resulted in an average oxygen level of 19 atomic % with a standard deviation of 0.77 atomic % for 6 areas analyzed. After plasma treatment, the oxygen level increased to an average of 26 atomic % with a standard deviation of 0.67 atomic % for 3 areas analyzed along the treated tow. There was little spot-to-spot variation on the treated tow, thus a homogenous treatment was achieved.

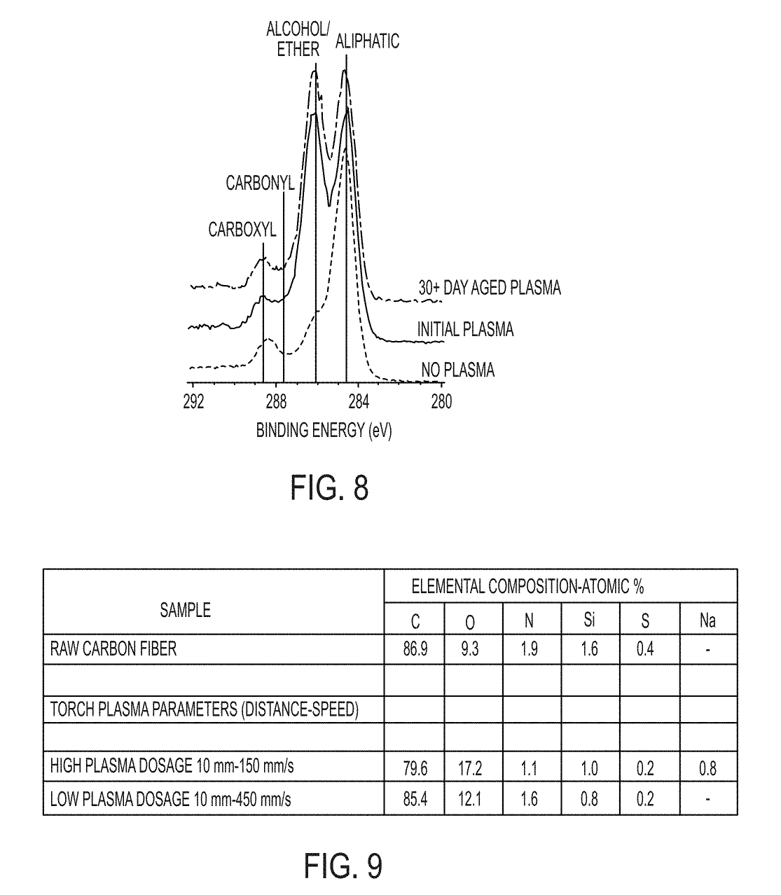

Additionally, the same plasma treated sample was aged at ambient room conditions to analyze whether the treatment would change over time. Within 2 weeks, the oxygen level only decreased by 4% from the initial treated surface. After 30 days, a more significant decrease in oxygen was measured. At the longer time of 30+ days, an 11.7% decrease in oxygen level was measured. With reference to FIG. 8, it was determined by XPS High Resolution Core Level C is spectra that the added oxygen was mainly in the form of an alcohol. The increase in alcohol groups on the carbon fiber tow provides a more polar surface for improved resin wet-out and more available hydroxyl (—OH) groups for adhesion within the composite matrix. Therefore, depending on environmental conditions, it may be possible to treat and store fibers for production.

Additional analysis was performed on plasma treating a raw carbon fiber tow with no epoxy sizing. For treatment of the raw carbon fiber, a stationary APAP torch from Plasmatreat NA was used with parameters set for a 10 mm distance at speeds of 150 mm/sec and 450 mm/sec. With reference to FIG. 9, XPS analysis again revealed a significant increase in atomic % oxygen after plasma treatment. The control raw carbon fiber without plasma was 9.3 atomic %. After plasma treatment at 150 mm/sec and 450 mm/sec, the atomic % O increased to 17.2 and 12.1, respectively. This data shows that the raw carbon fiber tow can be plasma treated prior to sizing to improve the wet-out and adhesion of the sizing resin, thus potentially adding to the overall strength of the final composite resin matrix. Therefore, the disclosed systems and methods for plasma treating fiber tows may be used in two ways: 1) treatment of the raw carbon fiber tow before resin sizing; and/or 2) treatment of the sized carbon fiber tow prior to composite molding.

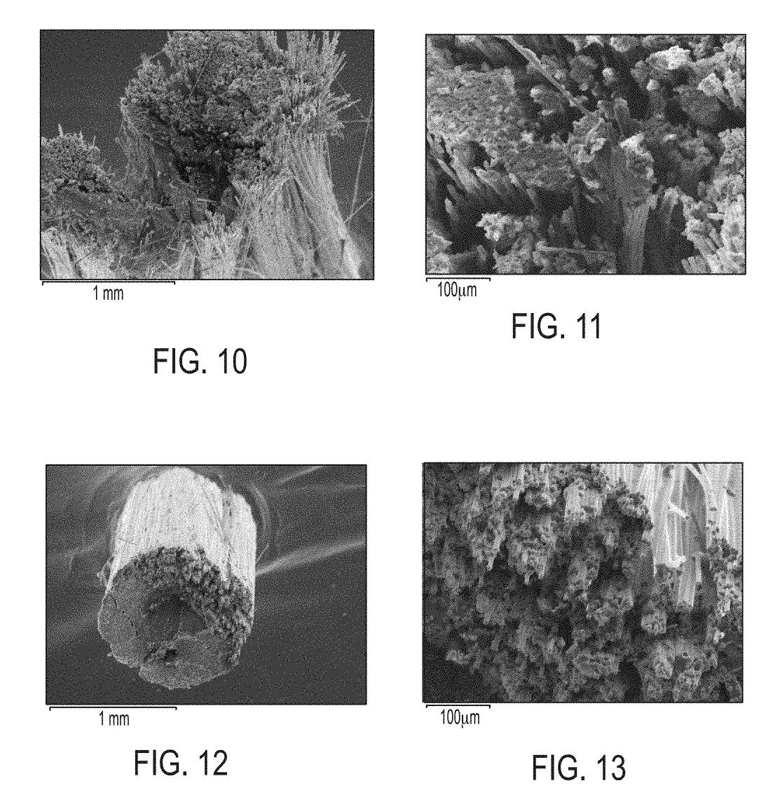

With reference to FIGS. 10-13, pultrusion samples made of a single tow of carbon fibers (epoxy sized) impregnated with epoxy resin were fractured and the cross-section were analyzed with SEM. Samples made with plasma treatment has better resin impregnation than samples without plasma treatment. FIG. 10 shows the overview of the cross-section of a fractured pultrusion sample at 50× magnification. Without plasma treatment, the fibers were loosely bonded with the resin matrix, indicating poor wetting properties. FIG. 11 shows the same cross-section at 250× magnification.

FIG. 12 shows the overview of the cross-section of a fractured pultrusion sample of a carbon fiber tow treated according to the present disclosure (again at 50× magnification). As shown, the plasma-treated samples have better adhesion with resin matrix. FIG. 13 shows the same cross-section at 250× magnification. The resin-impregnated, plasma-treated carbon fiber maintained a more uniform cylindrical structure, which is desired. In contrast, the filaments of the untreated tow are loose and frayed after impregnation. The improved impregnation and structure of the plasma treated carbon fiber tow will increase the load transfer between fibers and matrix, thus the overall mechanical performance of the composite. In a non-plasma treated sample exhibiting poor wetting properties, filaments are not fully impregnated with resin. Thus when the sample is under load, filaments may slip against each other and the composite fails.

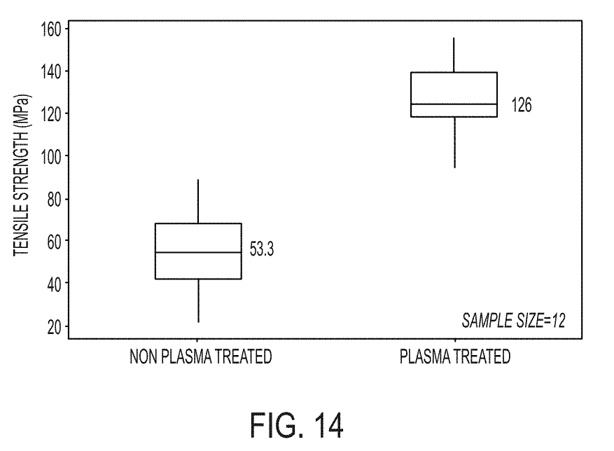

Evidence of the improved mechanical properties of composites including the disclosed plasma-treated carbon fiber tows is shown in FIG. 14. Carbon fibers with and without plasma treatment were compounded with epoxy resin. The compounded materials were then molded into 12 inch by 12 inch flat panels. Tensile bars were cut out of the panels for tensile testing. The results are shown in FIG. 14. The tensile strength of non-plasma treated samples was 53.3 MPa, while plasma treated samples had a strength of 126 MPa, a 136% increase. Accordingly, the mechanical property testing confirms that the surface chemistry change and improved wetting properties of the plasma-treated carbon fibers treated using the disclosed systems and methods results in a significant mechanical performance improvement.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A fiber tow treatment system, comprising:
an air-plasma source configured to emit a plasma stream;
a support surface spaced apart from the air-plasma source and configured to contact the plasma stream when emitted from the air-plasma source; and
first and second guides on opposing ends of the support surface and configured to align a moving fiber tow between the support surface and the air-plasma source.

2. The system of claim 1, wherein the support surface is configured to reduce a deflection of the fiber tow when it is treated by the plasma stream to at most 3 mm.

3. The system of claim 1, wherein the support surface is from 5 to 20 mm from the air-plasma source.

4. The system of claim 1, wherein the first and second guides are configured to maintain the fiber tow in a flat orientation while being treated by the plasma stream.

5. The system of claim 1, further comprising a third guide configured to receive the fiber tow and align it with the first and second guides.

6. The system of claim 1, wherein the air-plasma source is an atmospheric-pressure air plasma probe.

7. The system of claim 1, wherein the air-plasma source is configured to generate a plasma curtain.

8. The system of claim 7, further comprising a plurality of support surfaces perpendicular to the air-plasma source and in a path of the plasma curtain; and
a plurality of sets of first and second guides, each set configured to align a fiber tow between the support surface and the air-plasma source to be treated by the plasma curtain.

9. The system of claim 1, further comprising a take-up roll configured to receive the fiber tow after it has been treated by the plasma stream.

10. The system of claim 1, further comprising a chopper configured to cut the fiber tow into segments after it has been treated by the plasma stream.

11. The system of claim 1, further comprising a second air-plasma source configured to emit a second plasma stream; and
a second support surface perpendicular to the second air-plasma source and in a path of the second plasma stream.

12. A method, comprising:
continuously transferring a fiber tow through a first guide, across a support surface, and through a second guide; and
air-plasma treating the fiber tow as it crosses the support surface such that a deflection of the fiber tow from the air-plasma treatment is limited by the support surface.

13. The method of claim 12, wherein the air-plasma treatment is from a direction perpendicular to the support surface.

14. The method of claim 12, further comprising maintaining the fiber tow at a spacing of 3 mm or less from the support surface as it is continuously transferred across the support surface.

15. The method of claim 12, further comprising maintaining the fiber tow at a distance of 5 mm to 15 mm from a tip of an air-plasma source as it is continuously transferred across the support surface.

16. The method of claim 12, wherein a tension in the fiber tow is maintained at 1 to 12 MPa while it is continuously transferred through the first guide, across the support surface, and through the second guide.

17. The method of claim 12, further comprising continuously transferring multiple fiber tows across a support surface; and
air-plasma treating the fiber tows using a plasma curtain as they cross the support surface.

18. The method of claim 12, further comprising winding the fiber tow onto a roll after the air-plasma treatment.

19. The method of claim 12, further comprising chopping the fiber tow into a plurality of segments after the air-plasma treatment.

20. A method, comprising:
continuously transferring a fiber tow through a first guide, across first and second support surfaces, and through a second guide; and
air-plasma treating the fiber tow from a first direction as it crosses the first support surface and from a second direction as it crosses the second support surface, such that a deflection of the fiber tow from the air-plasma treatments is limited by the first and second support surfaces.
